(19) United States
(12) Patent Application Publication
(10) Pub. No.: US 2022/0236387 A1
(43) Pub. Date: Jul. 28, 2022

(54) TIME OF FLIGHT SENSING

(71) Applicant: AMS INTERNATIONAL AG, Jona (CH)

(72) Inventors: David Stoppa, Jona (CH); Miguel Bruno Vaello Paños, Jona (CH)

(21) Appl. No.: 17/616,638

(22) PCT Filed: Jun. 5, 2020
(86) PCT No.: PCT/EP2020/065634

§ 371 Date: Dec. 3, 2021

Related U.S. Application Data
(60) Provisional application No. 62/858,172, filed on Jun. 6, 2019.

(51) Int. Cl. G01S 7/4865; G01S 7/4863; G01S 7/481; G01S 17/894; G01B 11/22

(52) U.S. Cl. CPC G01S 7/4865; G01S 7/4863; G01B 11/22; G01S 17/894; G01S 7/4816

(57) ABSTRACT

A method of time of flight sensing, the method comprising using a source to emit pulses of radiation, and using an array of photodetectors arranged as a macropixel to detect radiation reflected from an object. During a sub-frame output from the macropixel, outputs from a subset of photodetectors of the macropixel are obtained, and during a subsequent sub-frame output from the macropixel, outputs from a different subset of photodetectors of the macropixel are obtained.

### TECHNICAL FIELD OF THE DISCLOSURE

The disclosure relates to a method of time of flight sensing, and to a time of flight sensor module and a time of flight sensor system.

### BACKGROUND OF THE DISCLOSURE

The present disclosure relates to a method of time of flight sensing. Time of flight sensing determines the distance of an object from a sensor using the known speed of light. In one example a pulse of light (e.g. at an infra-red wavelength) is emitted from a light source, and light reflected back towards the sensor from an object is detected. The source and the sensor may be located adjacent to one another (e.g. as part of the same integrated system). The distance between the sensor and the object is determined based upon the elapsed time between emission of the pulse of light and detection of the pulse of light by the sensor.

The time of flight sensor may be an imaging array which comprises an array of photodetectors. The photodetectors may for example be single-photon avalanche photodiodes (or some other form of photodetector). Many pulses of light may be emitted by a suitable pulsed illuminator and detected by the time of flight sensor. The imaging array may provide a ‘depth map’ based upon the detected photons and their arrival time, which indicates the measured distance of objects from the sensor in the form of an image.

Photodetectors and associated electronics may be arranged as macropixels, with each macropixel consisting of N photodetectors (e.g. sixteen photodetectors). Each macropixel may have associated electronics which receive and process outputs from the photodetectors of that macropixel. A plurality of macropixels may be arranged together to form the imaging array of a time of flight sensor.

In a conventional arrangement, the photodetectors of a macropixel may be multiplexed. That is, outputs from a first photodetector of the macropixel may be monitored and processed by sensor electronics, then outputs from a second photodetector of the macropixel may be monitored and processed, then outputs from a third photodetector of the macropixel, etc. There may for example be sixteen photodetectors in the macropixel.

When outputs from the sixteenth photodetector have been monitored and processed, outputs from the first photodetector may again be monitored and processed, etc. A disadvantage of this arrangement is that the frame rate, that is the rate at which the output from the macropixel is refreshed, is relatively low.

In another conventional arrangement, outputs from all photodetectors of a macropixel may be monitored in parallel, and processed as though they are a single photodetector. That is, the identity of a specific photodetector which provides an output is not known and instead the output is merely identified as being from the macropixel. Where this is done, a higher frame rate may be provided. However, the spatial resolution of the output is reduced.

It is therefore an aim of the present disclosure to provide a time of flight sensing method that addresses one or more of the problems above or at least provides a useful alternative.

### SUMMARY

In general, this disclosure proposes to overcome the above problems by using a subset of photodetectors for each output frame of a macropixel.

According to a first aspect of the present disclosure, there is provided a method of time of flight sensing, the method comprising using a source to emit pulses of radiation, and using an array of photodetectors arranged as a macropixel to detect radiation reflected from an object, wherein during a sub-frame output from the macropixel, outputs from a subset of photodetectors of the macropixel are obtained, and during a subsequent sub-frame output from the macropixel, outputs from a different subset of photodetectors of the macropixel are obtained.

Because a subset of photodetectors are used for each sub-frame output, the frame rate is increased. The frame rate may for example be increased by a factor of four or more (e.g. for a macropixel which consists of sixteen photodetectors). Because different subsets of photodetectors are used for each sub-frame output, spatial resolution is not reduced to the extent that would be seen if outputs from all of the photodetectors were combined together (as is conventional).

The macropixel may be one of an array of macropixels, outputs from which may be used to form a depth map (an image which represents distance to objects).

The photodetectors which make up the subsets of photodetectors may be distributed across the macropixel.

The photodetectors which make up the subsets of photodetectors may be pseudo-random distributions.

Identities of the photodetectors which make up the subsets of photodetectors may be stored in a memory associated with the macropixel. The memory may be referred to as a control memory.

The photodetectors which make up the subsets of photodetectors may be individual photodetectors. These may be distributed across the macropixel. In other words they may be provided not as a 2×2 group or similar group.

The photodetectors which make up the subsets of photodetectors may be arranged as groups of photodetectors.

At least some of the groups of photodetectors may partially overlap.

Each group of photodetectors may be a 2×2 array of photodetectors.

Outputs may be received from different macropixels in parallel. Different subsets of photodetectors of the macropixels may provide the parallel outputs.

The photodetectors may be single-photon avalanche photodiodes.

According to a second aspect of the present disclosure there is provided a time of flight sensor module comprising a sensor and sensor electronics, wherein the sensor comprises an array of photodetectors arranged as a macropixel to detect radiation reflected from an object, and the sensor electronics comprises a memory which is associated with the macropixel and which stores identities of a subset of photodetectors which will provide outputs during a given sub-frame, wherein the memory stores identities of a series of different subsets of photodetectors which will provide outputs during subsequent sub-frames.

The photodetectors which make up the subsets of photodetectors may be distributed across the macropixel.

The photodetectors which make up the subsets of photodetectors may be pseudo-random distributions.

The photodetectors which make up the subsets of photodetectors may be individual photodetectors.

The photodetectors which make up the subsets of photodetectors may be arranged as groups of photodetectors.

At least some of the groups of photodetectors may partially overlap.

Each group of photodetectors may be a 2×2 array of photodetectors. Larger groups of photodetectors may be used (e.g. 3×3 arrays, or more)

The macropixel may be one of a plurality of macropixels, each of which has an associated memory, with each memory storing identities of different series of subsets of photodetectors which will provide outputs during sub-frames. The memories may be referred to as a control memories.

The photodetectors may be single-photon avalanche photodiodes. These may be referred to as SPADS

According to a third aspect of the present disclosure there is provided a time of flight sensor system comprising the time of flight sensor module of the second aspect of the invention, an emitter configured to emit pulses of radiation, and an image processor.

Features of different aspects of the disclosure may be combined together.

Thus, embodiments of this disclosure advantageously allow the frame rate of time of flight sensing to be increased by a factor, without reducing the spatial resolution of the sensing by the same factor.

Finally, the present time of flight sensing method disclosed here utilises a novel approach at least in that a subset of photodetectors of the macropixel are used for each sub-frame, thereby allowing the frame rate to be increased.

### BRIEF DESCRIPTION OF THE PREFERRED EMBODIMENTS

Some embodiments of the disclosure will now be described by way of example only and with reference to the accompanying drawings, in which:

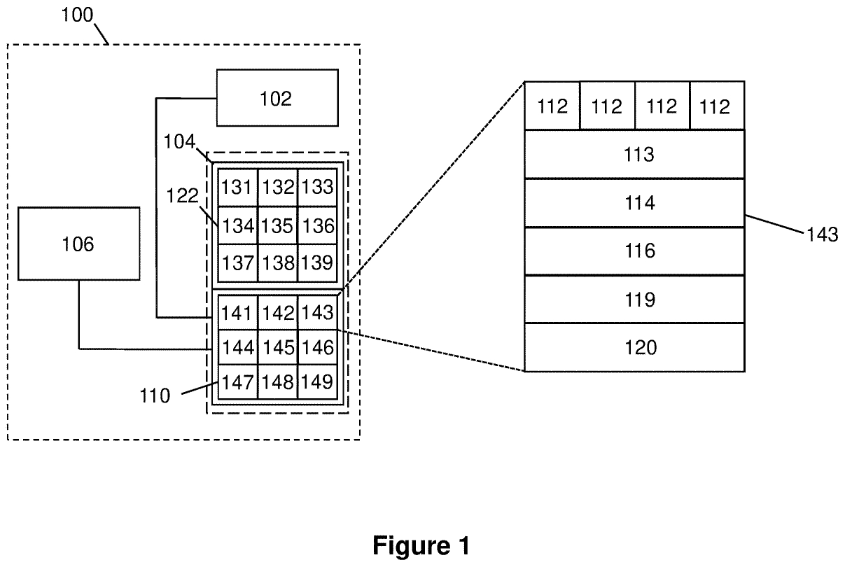

FIG. 1 schematically depicts a time of flight sensor system which may operate using a method according to an embodiment of the invention;

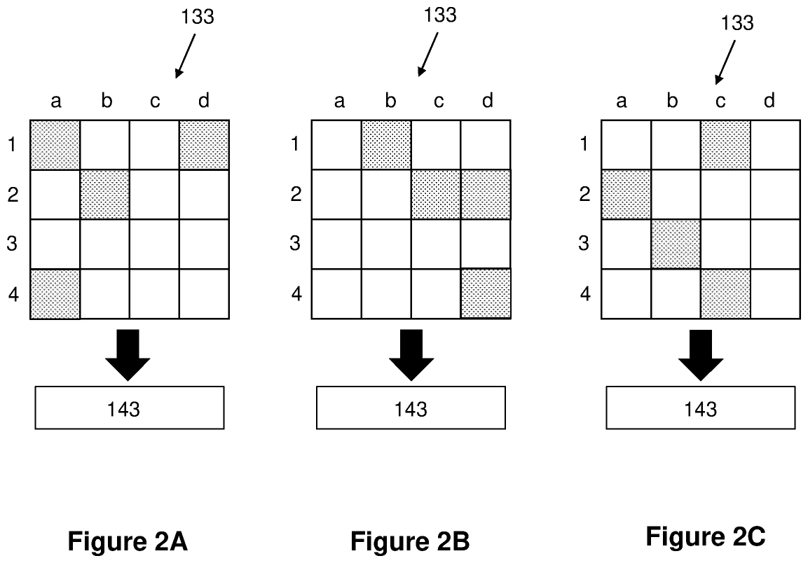

FIGS. 2A-2C schematically depicts a method of time of flight sensing according to an embodiment of the invention; and

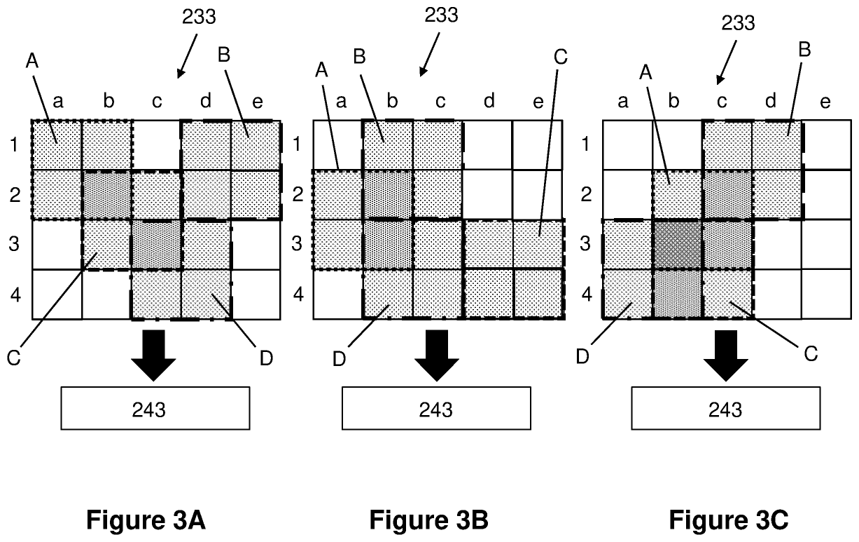

FIG. 3A-3C schematically depicts a method of time of flight sensing according to another embodiment of the invention.

### DETAILED DESCRIPTION OF THE PREFERRED EMBODIMENTS

Generally speaking, the disclosure provides a method of time of flight sensing in which outputs are received from a subset of photodetectors for each output frame of a macropixel.

Some examples of the solution are given in the accompanying Figures.

FIG. 1 schematically depicts a time of flight sensor system 100 which may be operated in accordance with an embodiment of the invention. The time of flight sensor system 100 comprises a light source 102, a sensor module 104 and an image processor 106. The sensor module 104 comprises a sensor 122 and sensor electronics 110. The sensor module 104 may be referred to as a time of flight sensor module. The light source 102 may be referred to as an illuminator or laser module and is configured to emit pulses of light (e.g. infra-red radiation). The light source 102 may comprise a vertical cavity surface emitting laser (VCSEL). The light source 102 may further comprise driver electronics, optics to shape light emitted by the VCSEL, and other electronics.

The sensor 122 is an array of photodetectors (e.g. single-photon avalanche diodes, which may be referred to as SPADs). These may be referred to as pixels. The pixels may be arranged as macropixels, that is sets of pixels which share some common (e.g. a histogram memory) electronics such as a front end. In FIG. 1 nine macropixels 131-139 are schematically depicted (other numbers of macropixels may be provided).

The sensor electronics 110 may be provided as a plurality of independently operating electrical circuits, referred to here as processing units. A processing unit may be associated with each group of pixels. In FIG. 1 there are nine processing units 141-149 (one for each group of pixels 131-39). Other numbers of processing units may be provided. Each processing unit 141-149 of the sensor electronics 110 may be provided directly beneath an associated pixel 131-139 using stacked-wafer technologies. However, for ease of illustration in the FIG. 1 the sensor electronics 110 are depicted separately from the sensor 122. The sensor 122 and sensor electronics 110 may be provided as a single integrated circuit.

One of the processing units 143 is depicted in more detail on the right hand side of FIG. 1. The processing unit 143 is associated with a macropixel 133. The macropixel 133 may for example comprise a 4×4 array of pixels. The processing unit 143 comprises a set of so called “front ends” 112, each of which receives an analogue voltage from a pixel of the macropixel and provides an output signal. Each front end 112 may comprise a quenching resistor and an inverter. Although four front ends 112 are depicted, sixteen front ends may be provided for a 4×4 pixel array.

In one example, the pixels are single-photon avalanche photodiodes. When a photon is incident upon a photodiode, an avalanche effect takes place in the photodiode, and an analogue voltage pulse is output from the photodiode. The analogue voltage pulse may have a generally triangular shape. The analogue voltage pulse is received by the front end 112, and the front end outputs a digital pulse, i.e. a pulse which has a generally rectangular shape.

A logic circuit 113 receives outputs from the front ends 112 and provides a single output. The logic circuit 113 may for example be an OR or XOR circuit. The logic circuit 113 may be referred to as compression electronics 113 because it receives multiple inputs and provides a single output.

The processing unit 143 further comprises a time to digital value convertor 114. As is depicted in FIG. 1, an output from the light source 102 is connected to the sensor electronics 110. When a pulse of light is emitted, this output initiates operation of a timer of the time to digital value converter 114. When a reflected photon is received by a pixel, and an associated front end 112 outputs a signal, this passes via the compression electronics 113 and causes an elapsed time value to be read from the time to digital value convertor 114. This may be referred to as a time stamp.

The time value is stored in a memory 116. The memory 116 may be a histogram memory. A histogram memory comprises bins representative of different elapsed times. When the photon is detected, the elapsed time value for that photon causes an increment of the bin which corresponds with the time value. Over time, many photons are detected and many associated elapsed times are measured. The data in the histogram memory represents the number of detected photons as a function of elapsed time. Peaks in the data are typically indicative of objects which have reflected the photons. The times associated with the peaks are indicative of the distance to those objects. The distance resolution (which may be referred to as depth resolution) provided by the histogram memory will depend upon the time duration of each bin.

The processing unit 143 further comprises a processor 119 and a memory 120 (e.g. a register). The memory 120 stores instructions which are used by the processor 119 to control operation of the macropixel 133. The memory 120 may be referred to as a control memory 120. The control memory 120 may for example determine whether the macropixel is configured to detect photons using outputs from individual photodetectors separately or using combined outputs from photodetectors (these modes of operation are described below). The control memory 120 may for example store a series of subsets of pixels to be used for frames of output (as described below). In general, a control memory may be associated with each macropixel.

In general, a group of pixels which is connected to common electronics such as compression electronics 113 and a histogram memory 114 may be referred to as a macropixel.

The system 100 may further comprise a time to distance converter (not depicted), which receives histogram memory outputs in the form of digital representations of time, and converts these times into distances. The time to distance convertor is typically not implemented at a macropixel level because it is too bulky, but instead is provided outside of the macropixel array. Outputs from the time to distance convertor 118 are passed to the image processor 106, which combines the outputs to form an image which depicts the distances to objects in the field of view of the time of flight sensor system 100. The image may be referred to as a depth map.

FIGS. 2A-2C schematically depict a method of time of flight sensing according to an embodiment of the invention. FIGS. 2A-2C depict a single macropixel 133 of the array of FIG. 1, together with the processing unit 143 associated with that macropixel. The macropixel 133 consists of sixteen photodetectors, which are referred to as pixels herein for ease of reference. The pixels may for example be single-photon avalanche diodes (SPADs).

In a conventional method, outputs from each of the 16 pixels 133 are received by the processing unit 143 in turn (this is a known time-multiplexing arrangement). Conventionally, a raster-scan arrangement is used, e.g. controlled by a control memory.

In FIG. 2A letters have been used to identify pixel columns of the macropixel 133 and numbers have been used to identify pixel rows of the macropixel (this has been done in a manner which corresponds with the way in which positions on a chess board are identified). Thus, the top left pixel is a1 and the bottom right hand pixel is d4.

In a conventional arrangement, a raster-scan of all of the pixels is performed, with each of the pixels along each row being addressed in turn: a1, b1, c1, d1, a2, b2, etc. This is a conventional time multiplexing arrangement. The frame rate of the macropixel 133, i.e. the rate at which the output from the macropixel is refreshed, may be relatively low.

In an embodiment of the invention, outputs from four pixels of the macropixel 133 are sent to the processing unit 143 during each data acquisition (the four pixels are a subset of the pixels of the macropixel). The selected pixels from which outputs are received may be distributed in a pseudo-random pattern (which may be stored in the control memory 120—see FIG. 1). The selected pixels are all active at the same time. The compression electronics 113 (see FIG. 1) will receive an input from any of the four pixels and provide an output which does not distinguish which pixel provided the input. Thus, in the example depicted in FIG. 2A, an output is received from any of pixels a1, d1, b2 or a4. Multiple outputs are received and stored in the histogram memory 114. This may continue for a predetermined amount of time, or until sufficiently well-defined peaks have been identified in the data stored in the histogram memory (as explained further below). The data acquisition is then complete and the next data acquisition is begun. The data acquisition may be referred to as a sub-frame.

The second data acquisition is depicted in FIG. 2B. In this example, in the second data acquisition outputs are received from pixels b1, c2, d2 and d4 (this is the second subset of pixels). Again, the pixels are distributed in a pseudo-random pattern (which may be stored in the control memory 120). Again, all four pixels b1, c2, d2 and d4 are active at the same time, and the compression electronics 113 does not distinguish between outputs from the pixels. The outputs are sent to the processing unit 143. Once a predetermined time has elapsed, or peaks have been identified in the data, the second data acquisition (sub-frame) is complete.

The next data acquisition then commences. This third data acquisition (sub-frame) is depicted in FIG. 2C. In the third data acquisition outputs are received from pixels c1, a2, b3 and d4 (this is the third subset of pixels). Again, the pixels are distributed in a pseudo-random pattern (which may be stored in the control memory 120). The outputs are passed to the processing unit 143.

A further data acquisition then occurs, in which outputs from a different selection (subset) of four pixels a1-d4 are sent to the processing unit 143. This data acquisition (sub-frame) is not depicted. The outputs for this data acquisition may be obtained from pixels a3, c3, d3 and b4. These are the only pixels which have not yet provided outputs. Once this fourth subset of pixels has provided outputs, all pixels have provided outputs. The acquisition of a frame may be considered to be complete. The set of data acquisitions may then be repeated for the next frame.

In general, a set of data acquisitions which make up a frame may be arranged such that each pixel a1-d4 is active (enabled) at least once during the frame. The frame may comprise more than four data acquisitions. Some pixels may be active (enabled) more than once during a set of data acquisitions which make up a frame.

In the above description, and elsewhere in this document, the term “frame” may be interpreted as meaning acquisition of data from all pixels of a macropixel. Where the context allows, the term “frame” may refer to acquisition of data from all pixels of all macropixels of the sensor module 104.

This embodiment of the invention is advantageous because it provides a frame rate which is faster than the frame rate obtained if outputs are received from all sixteen pixels of the macropixel 133 in series. For example, if the frame consists of four data acquisitions (sub-frames), then the frame rate is four times faster than the conventional frame rate. This improved frame rate is achieved whilst at the same time avoiding a large reduction in spatial resolution that would be seen if a conventional method of increasing frame rate where to be applied, i.e. a method in which all outputs of the pixels a1-d4 were combined together such that the processing unit 143 could not discriminate which pixel provided an output signal. Although a reduction of spatial resolution will be seen, the reduction is less than would be seen with the prior art method.

The period of time during which outputs are received from a pixel (or a subset of pixels) may be fixed. Outputs may be received from a pixel (or subset of pixels) until for example 10,000 pulses have been emitted by the source 102 (or some other number of pulses). The repetition rate of the light source 102 may for example be 10 MHz. A combination of a repetition rate of 10 MHz and 10,000 pulses per output will mean that an output is received from a given pixel (or subset of pixels) for 10 ms, following which an output is received from the next pixel (or subset of pixels).

In a conventional arrangement in which each pixel of sixteen pixel macropixel provides an output, the resulting frame rate is 1/(16×0.01)=6.25 Hz. In other examples the number of pulses received at each pixel may be different. e.g. 100,000 pulses. Where this is the case, the frame rate may be lower. Increasing the repetition rate of the light source may increase the frame rate but may be difficult to achieve and will use more power. When data acquisition from subset of pixels is used, according to embodiments of the invention, the frame rate is increased.

In an alternative conventional approach, the period of time during which outputs are received from a pixel may be based upon properties of the photons detected by the pixel (or subset of pixels). As explained further above, time stamps corresponding with the times at which photons are detected are stored in the histogram memory 116. A processor which forms part of the processing unit 143 may determine whether a peak (or peaks) is present in the data stored in the histogram memory. When a peak (or peaks) is identified (e.g. with a sufficiently good signal to noise ratio) the output from that pixel (or subset of pixels) may be judged to be sufficient. Output from the next pixel (or subset of pixels) may then be obtained. In a conventional arrangement in which all pixels of a sixteen pixel macropixel are used, a typical frame rate may for example be around 10 Hz. The frame rate may to some extent vary depending upon the proximity of an object to the system 100. When a subset of pixels is used for each data acquisition, according to embodiments of the invention, the frame rate is increased.

In general a faster frame rate is desirable because this allows the depth map to more accurately show a quickly changing distance to an object. Embodiments of the invention provide a faster frame rate because the frame is built up using outputs from subsets of pixels of a macropixel (instead of outputs from each pixel of the macropixel separately).

For example, in an embodiment such as the embodiment of FIG. 2 in which outputs are received from % of the pixels in each subset of pixels, the frame rate is increased by a factor of four.

Although the embodiment depicted in FIGS. 2A-C selects four pixels per subset, in other embodiments other numbers of pixels may be selected. In general, different subsets of pixels of a macropixel 133 may be selected per data acquisition (sub-frame). The control memory 120 may store the identities of the subsets of pixels as a series of subsets, and may cycle the macropixel 133 through the series of subsets. A frame may be considered to be complete when each pixel of the macropixel has been active (enabled) at least one time during the frame acquisition. A different series of subsets of pixels may be stored (and used) for each macropixel 133-139. Alternatively, the same series may be stored (and used), but with each macropixel 133-139 starting at a different point in the series. In general, the macropixels 133-139 may be controlled so that no two macropixels use the same subset of pixels at the same time.

Although embodiments of the invention increase the frame rate by a given factor (e.g. a factor of four), they do not reduce the spatial resolution of the system by a corresponding factor. This is because using different subsets of pixels on a macropixel provides good spatial resolution. This may be understood with reference to an example as set out below.

In this example the system 100 is facing a first wall which is 1 m away and a second wall which is 2 m away. The walls are connected by a vertical edge which extends to a depth of 1 m. The pixels in columns a and b of the macropixel 133 all see the first wall, which has a distance of 1 m. The pixels in columns c and d of the macropixel 133 all see the second wall, which has a distance of 2 m.

When the data acquisition depicted in FIG. 2A is performed, three pixels from columns a and b have an output of 1 m, and one pixel from columns c and d has an output of 2 m. The histogram memory will have two peaks, one peak corresponding with the 1 m wall and one peak corresponding with the 2 m wall. The heights of the peaks provide information about the numbers of reflected photons received from the 1 m wall and the 2 m wall. When the data acquisition depicted in FIG. 2B is performed, one pixel from columns a and b has an output of 1 m, and three pixels from columns c and d have an output of 2 m. Now, the peak for the 2 m wall is larger than it was before, and the 1 m peak is smaller. When the data acquisition depicted in FIG. 2C is performed, two pixels from columns a and b have an output of 1 m, and two pixels from columns c and d have an output of 2 m. The 1 m peak is now a bit larger than it was and the 2 m peak is now a bit smaller. The heights of the peaks, together with the known positions of the pixel subsets which provided the peaks, allow the positions of the 1 m and 2 m walls to be identified. That is, it can be identified that there is a 1 m wall facing columns a and b, and a 2 m wall facing columns c and d.

In order to simply the above explanation it has been assumed that the number of photons reflected from the 2 m wall to the sensor 122 is the same as the number of photons reflected from the 1 m wall to the sensor. In practice, less photons will be received from the 2 m wall because it is further away. Analysis of detected peaks may take into account that objects which are more distant will provide a lower peak than objects that are closer.

In general, a macropixel may consist of any number of pixels, e.g. 3×3, 4×4, 5×5, 6×6, etc. pixels. In some embodiments the number of rows of a macropixel may be different to the number of columns of a macropixel (e.g. as depicted). Thus, for example a macropixel may consist of 5×4, 4×5, 6×4, or 4×6, etc. pixels. In general, a macropixel may be rectangular. Embodiments of the invention may be implemented in macropixels of any shape. In general, embodiments of the invention may be applied when a macropixel is an array of at least 3 pixels by at least 3 pixels (i.e. 3×3 pixels or more).

An alternative embodiment of the invention is schematically depicted in FIGS. 3A-C. In this embodiment the macropixel is an array of 5×4 pixels. However, the macropixel may have some other number of pixels. In the embodiment depicted in FIGS. 3A-C, outputs are sent from subsets of pixels which comprise groups of four pixels (the four pixels being arranged as a square). As with the embodiment depicted in FIGS. 2A-C, rows and columns of pixels are identified using numbers and letters respectively.

A first sub-frame is depicted in FIG. 3A. Outputs from pixels a1, b1, a2, b2 are sent to the processing unit 243 (this is a first data acquisition). The perimeter of this group of pixels is marked using a dotted line, and the group of pixels is labelled A. When an output passes from the group of pixels A to the processing unit 243, the output does not identify which of the pixels a1, b1, a2, b2 received the detected photon. Thus, the spatial resolution which is provided is reduced compared with the resolution seen when outputs from individual pixels are received separately by the processing unit.

After a predetermined number of pulses of the light source, or after a peak has been identified in the output, the method then moves to a second group of pixels B (this is a second data acquisition). This second group of pixels B comprises pixels d1, e1, d2, e2 and its perimeter is marked with a dashed line. When an output passes from the group of pixels B to the processing unit 243, the output does not identify which of the pixels d1, e1, d2, e2 received the detected photon.

Outputs are then received from a third group of pixels C which consists of pixels b2, c2, b3, c3 (this is a third data acquisition). These pixels are outlined by a dashed line with shorter dashes than that used for the second group of pixels B. As may be seen, pixel b2 already formed part of the first group of pixels A. This overlap between two groups of pixels A, C is beneficial because it recovers spatial resolution that would otherwise be lost due to the pixel groups being 2×2 pixels. The same applies for other overlaps of groups of pixels.

Finally, a fourth group of pixels D which consists of pixels c3, d3, c4, d4 provides an output to the processing unit 243 (this is a fourth data acquisition). Again, there is overlap at pixel c3 with a previous pixel group C.

A second sub-frame is depicted in FIG. 3B. In this sub-frame outputs from a first group of pixels consisting of pixels a2, b2, a3, b3 are provided to the processing unit 243 (first data acquisition). Outputs are then provided from a second group B of pixels b1, c1, b2, c2. Outputs are then provided from a third group of pixels C, d3, e3, d4, e4. Finally, outputs are provided from a fourth group of pixels D, b3, c3, b4, c4. Again, two pixels b2, b3 provide outputs on two separate occasions. As noted above, this beneficially improves spatial resolution.

A third sub-frame is depicted in FIG. 3C. In this sub-frame outputs from a first group of pixels consisting of pixels b2, c2, b3, c3 are provided to the processing unit 243 (first data acquisition). Outputs are then provided from a second group B of pixels c1, d1, c2, d2. Outputs are then provided from a third group of pixels C, b3, c3, b4, c4. Finally, outputs are received from a fourth group of pixels D, a3, b3, a4, b4. Three pixels c2, c3, b4 provide outputs on two separate occasions, and one pixel b3 provides outputs on three separate occasions. As noted above, this beneficially improves spatial resolution.

As with the embodiment described above in connection with FIG. 2, the groups of pixels A-D may be pseudo-random distributions. The distributions may be saved in a control memory. In general, the groups of pixels A-D may be distributed across the macropixel 233. As noted above, the groups of pixels for each sub-frame are a subset of the pixels of the macropixel 233.

This embodiment of the invention is advantageous because it provides a frame rate which is faster than the frame rate that would be achieved if outputs where received from each pixel separately, and in addition provides spatial resolution which is better than the resolution which would be achieved if all of the pixels were connected together to provide a single macropixel output. In particular, the overlaps between groups of pixels provide spatial information that would otherwise not be obtained. In the real world, most objects consist of an area and an edge. Using groups of pixels in the manner described in connection with FIG. 3 provides good results because it looks at areas, whilst at the same time the overlaps between areas are helpful to identify edges.

As with the embodiment depicted in FIGS. 2A-C, the embodiment depicted in FIGS. 3A-C may be understood with reference to an example. In this example the system 100 is facing a first wall which is 1 m away and a second wall which is 2 m away. The walls are connected by a vertical edge which extends to a depth of 1 m. The pixels of column a of the macropixel 233 see the first wall, which has a distance of 1 m. The pixels of columns d-e of the macropixel 233 all see the second wall, which has a distance of 2 m.

In the first sub-frame, depicted in FIG. 3A, the output from the first group of pixels A will include a peak indicating an object at 1 m and a peak indicating an object at 2 m. The output from the second, third and fourth groups of pixels B will have a peak indicating an object at 2 m (but no peak indicating an object at 1 m). Since the positions of the groups of pixels are known, the outputs can be used to identify that there is a 1 m wall facing column a, and a 2 m wall facing columns b to d. Because the third group of pixels C partially overlaps with the first group of pixels A, this allows the position of the step between the walls to be determined with a spatial resolution that is smaller than the size of the pixel groups. The second and third sub-frames 3B, 3C may be used to obtain additional spatial information.

In general, at least some groups of pixels which make up a sub-frame may partially overlap. This will provide improved spatial resolution compared with a situation in which groups of pixels of a sub-frame do not overlap.

In the described embodiments of the invention each macropixel consists of sixteen pixels. In other embodiments each macropixel may have a different number of pixels. Different groupings of those pixels may be used. For example, groups of pixels consisting of more than four pixels may be used.

In some embodiments, the number of groups of pixels may be equal to or less than % of the number of pixels which together form a macropixel.

In FIG. 1, the front ends 112, compression electronics 113, time to digital value convertor 114, memory 116, processor 119 and control memory 120 are all depicted as a processing unit 143 which is formed in the same integrated circuit as its associated macropixel 133. This may be the same for each of the macropixels 131-139. The electrical circuits 141-149 may be located beneath the sensor 122. Alternatively the electrical circuits may be located around a periphery of the sensor 122. Providing the electrical circuits beneath the sensor 122 may be preferable because it may provide scalability and may provide superior performance.

It is not essential that all of the elements of the electrical circuits are in the integrated circuit. One or more of the elements may be located remotely from the integrated circuit. For example, the time to distance converter may form part of a different integrated circuit. However, providing all of the elements in the integrated circuit may be the most efficient configuration.

In described embodiments of the invention the pixels of the macropixels are photodetectors. In described embodiments, the photodetectors are avalanche photodiodes. However, other photodetectors may be used, such as a CCD array or an array of PPD photodiodes.

A memory which is not a histogram memory may be used (e.g. a RAM).

In described embodiments of the invention, the subsets of pixels are distributed as pseudo-random distributions across a macropixel. However, other distributions of pixels may be used, provided that the pixels of the distributions are generally spread across the macropixel. The term “generally spread” may be interpreted as meaning that the pixels are not all on one side or in one corner of the macropixel. For example, in each subset a pixel may be included in % of columns and/or % of rows of the macropixel.

Embodiments of the invention may be used in many different applications, such as for example a smartphone, a tablet computer, a laptop computer, a computer monitor, a car dashboard and/or navigation system, an interactive display in a public space, a home assistant, etc.

### LIST OF REFERENCE NUMERALS

100—Time of flight sensor system
102—Light source
104—Time of flight sensor module
106—Image processor
110—Sensor electronics
112—Front ends
113—Compression electronics
114—Time to digital value convertor
116—Memory
119—Processor
120—Control memory
122—Sensor
131-139—Macropixels
141-149—Processing units
233—Macropixel
243—Processing unit

The skilled person will understand that in the preceding description and appended claims, positional terms such as ‘above’, ‘along’, ‘side’, etc. are made with reference to conceptual illustrations, such as those shown in the appended drawings. These terms are used for ease of reference but are not intended to be of limiting nature. These terms are therefore to be understood as referring to an object when in an orientation as shown in the accompanying drawings.

Although the disclosure has been described in terms of preferred embodiments as set forth above, it should be understood that these embodiments are illustrative only and that the claims are not limited to those embodiments. Those skilled in the art will be able to make modifications and alternatives in view of the disclosure which are contemplated as falling within the scope of the appended claims. Each feature disclosed or illustrated in the present specification may be incorporated in any embodiments, whether alone or in any appropriate combination with any other feature disclosed or illustrated herein.

1. A method of time of flight sensing, the method comprising:
using a source to emit pulses of radiation; and
using an array of photodetectors arranged as a macropixel to detect radiation reflected from an object; wherein
during a sub-frame output from the macropixel, outputs from a subset of photodetectors of the macropixel are obtained; and
during a subsequent sub-frame output from the macropixel, outputs from a different subset of photodetectors of the macropixel are obtained.

2. The method of claim 1, wherein the photodetectors which make up the subsets of photodetectors are distributed across the macropixel.

3. The method of claim 1, wherein the photodetectors which make up the subsets of photodetectors are pseudo-random distributions.

4. The method of claim 1, wherein identities of the photodetectors which make up the subsets of photodetectors are stored in a memory associated with the macropixel.

5. The method of claim 1, wherein the photodetectors which make up the subsets of photodetectors are individual photodetectors.

6. The method of claim 1, wherein the photodetectors which make up the subsets of photodetectors are arranged as groups of photodetectors.

7. The method of claim 6, wherein at least some of the groups of photodetectors partially overlap.

8. The method of claim 6, wherein each group of photodetectors is a 2×2 array of photodetectors.

9. The method of claim 1, wherein outputs are received from different macropixels in parallel, with different subsets of photodetectors of the macropixels providing the parallel outputs.

10. The method of claim 1, wherein the photodetectors are single photon avalanche photodiodes.

11. A time of flight sensor module comprising a sensor and sensor electronics; wherein:
the sensor comprises an array of photodetectors arranged as a macropixel to detect radiation reflected from an object; and
the sensor electronics comprises a memory which is associated with the macropixel and which stores identities of a subset of photodetectors which will provide outputs during a given sub-frame; wherein
the memory stores identities of a series of different subsets of photodetectors which will provide outputs during subsequent sub-frames.

12. The time of flight sensor module of claim 11, wherein the photodetectors which make up the subsets of photodetectors are distributed across the macropixel.

13. The time of flight sensor module of claim 11, wherein the photodetectors which make up the subsets of photodetectors are pseudo-random distributions.

14. The time of flight sensor module of claim 11, wherein the photodetectors which make up the subsets of photodetectors are individual photodetectors.

15. The time of flight sensor module of claim 11, wherein the photodetectors which make up the subsets of photodetectors are arranged as groups of photodetectors.

16. The time of flight sensor module of claim 15, wherein at least some of the groups of photodetectors partially overlap.

17. The time of flight sensor module of claim 15, wherein each group of photodetectors is a 2×2 array of photodetectors.

18. The time of flight sensor module of claim 11, wherein the macropixel is one of a plurality of macropixels, each of which has an associated memory, with each memory storing identities of different series of subsets of photodetectors which will provide outputs during sub-frames.

19. The time of flight sensor module of claim 11, wherein the photodetectors are single-photon avalanche photodiodes.

20. A time of flight sensor system comprising the time of flight sensor module of claim 11, an emitter configured to emit pulses of radiation, and an image processor.
